(19) United States
(12) Patent Application Publication
(10) Pub. No.: US 2017/0322067 A1
(43) Pub. Date: Nov. 9, 2017

(54) DEVICE AND METHOD FOR DETECTING WATER LEVEL OF WATER TRAP IN FUEL CELL

(71) Applicants: Hyundai Motor Company, Seoul (KR); Kia Motors Corporation, Seoul (KR); Sejong Industrial Co., Ltd., Ulsan (KR)

(72) Inventors: Hyo Sub Shim, Suwon (KR); Bu Kil Kwon, Suwon (KR); Ho Suh, Yongin (KR); Seok Yun Jang, Yongin (KR)

(21) Appl. No.: 15/371,735

(22) Filed: Dec. 7, 2016

(30) Foreign Application Priority Data
May 9, 2016 (KR) 10-2016-0056187

(51) Int. Cl. G01F 25/00; G01K 13/00; G01F 23/26

(52) U.S. Cl. CPC G01F 25/0061; G01F 23/26; G01K 13/00

(57) ABSTRACT

A device and a method for detecting a water level of a water trap in a fuel cell can accurately output a water level of water collected in the water trap by reaction of the fuel cell. The device and the method for detecting a water level of a water trap can detect a change in a surrounding temperature of a water level sensor by mounting a separate temperature sensor in the water level sensor and accurately output the water level in the water trap regardless of the change of the surrounding temperature through a water sensor output value correction algorithm based on a detected temperature.

### CROSS-REFERENCE TO RELATED APPLICATION

This application claims under 35 U.S.C. §119(a) the benefit of Korean Patent Application No. 10-2016-0056187 filed on May 9, 2016, the entire contents of which are incorporated herein by reference.

### BACKGROUND

### (a) Technical Field

The present invention relates to a device and a method for detecting a water level of a water trap, more particularly, to a device and a method for detecting a water level of a water trap in a fuel cell, which can accurately output a water level of water collected in the water trap by reaction of the fuel cell.

### (b) Description of the Related Art

A primary energy source of a fuel cell vehicle is caused from a generating device called a fuel cell stack, and the fuel cell stack is a device in which oxygen in air and hydrogen supplied from the outside chemically react to each other to generate energy.

When hydrogen as fuel is supplied to an anode of the fuel cell stack and air as oxidant is supplied to a cathode of the fuel cell stack, the supplied hydrogen is separated into hydrogen ions and electrons by a catalyst layer oxidation reaction in the anode. The generated hydrogen ions are supplied to the cathode through a polymer electrolyte membrane in the fuel cell stack, and the electrons are supplied to the cathode through an external circuit. As a result, in the cathode, electricity is generated through a principle in which the supplied oxygen and the electrons meet to generate oxygen ions by a catalyst layer reduction reaction and the hydrogen ions and the oxygen ions are combined to generate water.

In this case, since the water generated in the fuel cell stack interrupts the flow of the oxygen and the hydrogen, the water needs to be removed from the fuel cell stack. Therefore, the generated water drops down by gravity according to a design structure of the fuel cell stack to be collected in a water trap.

When the water collected in the water trap reaches a predetermined water level or more, an opening control of a drain valve is performed so as to discharge the water to the outside by detecting that the collected water reaches the predetermined water level or more by a water level sensor.

As described above, only by accurately detecting the water level of the water stored in the water trap, the current water level in the water trap can be accurately determined and moreover, a time of discharging the water to the outside can be accurately controlled.

However, the water level sensor mounted on the water trap as a capacitive analog water level sensor shows a water level output within a normal range under a room temperature condition, but shows an output different from an actual water level when the temperature of the water and a surrounding environmental temperature are changed.

For example, the water level sensor has a tendency to output a water level which is higher than the actual water level as the temperature of the water increases.

The above information disclosed in this Background section is only for enhancement of understanding of the background of the invention and therefore it may contain information that does not form the prior art that is already known in this country to a person of ordinary skill in the art.

### SUMMARY

The present invention provides a device and a method for detecting a water level of a water trap, which can detect a change in a surrounding temperature of a water level sensor by mounting a separate temperature sensor in the water level sensor and accurately output the water level in the water trap regardless of the change of the surrounding temperature through a water sensor output value correction algorithm based on a detected temperature.

In one aspect, the present invention provides a device for detecting a water level of a water trap, including: a water level sensor mounted on the water trap; a temperature sensor mounted on the water level sensor; and a control unit correcting an output value of the water level sensor depending on a current detection temperature of the temperature sensor to an output value of the water level sensor depending on a reference temperature.

In a preferred embodiment, the temperature sensor may be mounted on the periphery of an electrode of the water level sensor.

In another preferred embodiment, the control unit may store a correction value for correcting an output value of the water level sensor for each current temperature detected by the temperature sensor to the output value of the water level sensor depending on the reference temperature.

In another aspect, the present invention provides a method for detecting a water level of a water trap, including: i) acquiring output data of the water level sensor at a reference temperature; ii) acquiring output value data of the water level sensor for each surrounding temperature; iii) calculating a correction value for the output value of the water level sensor for each surrounding temperature based on an output value of the water level sensor at the reference temperature; and iv) correcting the output value of the water level sensor for each surrounding temperature based on the calculated correction value.

In step i), as the output data of the water level sensor, an output value of the water level sensor for a condition in which a water level in the water trap is a low water level or a full water level at the reference temperature and an output value of the water level sensor in a section between the low water level and the full water level may be acquired.

In step ii), the output value data of the water level sensor for each surrounding temperature may be acquired under the condition in which the water level in the water trap is the low water level.

Step iii) may include iii-1) a process of setting a temperature in the chamber to the temperature lower than the reference temperature and thereafter, increasing the temperature in the chamber to a predetermined temperature higher than the reference temperature at a predetermined temperature step interval, in a state in which the water trap on which the water level sensor including the temperature sensor is mounted is deployed in an environmental chamber, the temperature in the chamber being increased while maintaining each temperature step for a predetermined time; iii-2) a process of recording the output value of the water level sensor and current temperature data at the time when each temperature step ends; and iii-3) a process of subtracting the output value of the water level sensor at the time when each temperature step ends from the output value of the water level sensor at the reference temperature to calculate the correction value for correcting the output value of the water level sensor.

The method may further include: after step iii-3), iii-4) a process of setting the temperature in the chamber to the temperature higher than the reference temperature and thereafter, decreasing the temperature in the chamber to the predetermined temperature lower than the reference temperature at the predetermined temperature step interval, the temperature in the chamber being decreased while maintaining each temperature step for a predetermined time; iii-5) a process of recording the output value of the water level sensor and the current temperature data at the time when each temperature step ends; iii-6) a process of subtracting the output value of the water level sensor at the time when each temperature step ends from the output value of the water level sensor at the reference temperature to calculate the correction value for correcting the output value of the water level sensor; and iii-7) calculating a final correction value by averaging the correction value calculated in step iii-3) and the correction value calculated in step iii-6).

Step iv) may be achieved by finding, when a current temperature detected by the temperature sensor is different from the reference temperature, the correction value corresponding to the current temperature in the memory of the control unit and outputting an output value of the water level sensor, on which the found correction value is reflected.

In another aspect, the present invention provides a non-transitory computer readable medium containing program instructions executed by a processor, the computer readable medium including: program instructions that acquire output data of a water level sensor at a reference temperature; program instructions that acquire output value data of the water level sensor for each surrounding temperature; program instructions that calculate a correction value for the output value of the water level sensor for each surrounding temperature based on an output value of the water level sensor at the reference temperature; and program instructions that correct the output value of the water level sensor for each surrounding temperature based on the calculated correction value.

The present invention provides the following effects through the means for solving problems.

First, a separate temperature sensor is mounted in a water level sensor to detect a change of a current surrounding temperature of the water level sensor and correct and output an output value of the water level sensor for each current detected temperature according to an output value of the water level sensor at a reference temperature, and as a result, the water level sensor can continuously output a water level in a water trap with accuracy regardless of the change of the surrounding temperature.

Second, accuracy of an output value indicating the water level of a capacitive analog water level sensor can be improved and a problem that a water level sensor in the related art shows an output different from an actual water level when the temperature of water and a surrounding environmental temperature are changed can be solved.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 (RELATED ART) is a schematic view illustrating a water trap of a fuel cell system and a water level sensor in the related art, which is mounted on the water trap;

FIG. 2 is a schematic view illustrating a water trap of a fuel cell system and a water level sensor of the present invention, which is mounted on the water trap;

FIG. 3 is a graph showing a change of an output value of the water level sensor at a reference temperature according to a water level in the water trap;

FIG. 4 is a graph showing a change of an output value of the water level sensor for each surrounding temperature when the water level in the water trap has a low-water level condition;

FIG. 5 is a graph showing an example of correcting the output value of the water level sensor according to a current temperature as a method for detecting a water level according to the present invention;

FIG. 6 is a graph showing comparison of the output value of the water level sensor for each surrounding temperature of the present invention for a specific water level and the output value of the water level sensor in the related art; and

FIG. 7 is a flowchart illustrating an example of calculating a correction value K for the output value of the water level sensor in the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, preferred embodiments of the present invention will be described in detail with reference to the accompanying drawings.

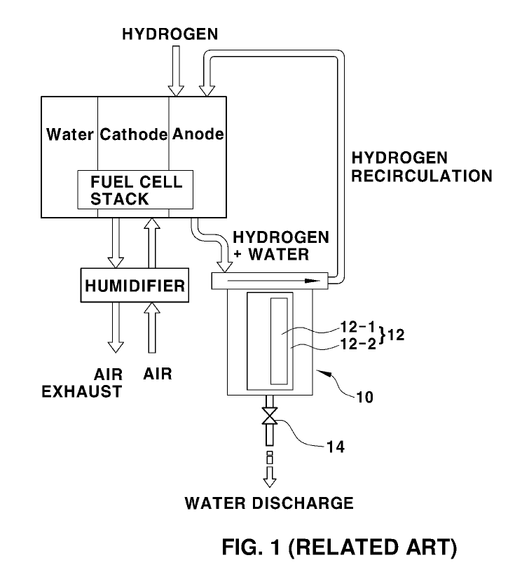

First, an operating flow of a water trap mounted in a fuel cell system and a water level sensor mounted on the water trap will be described below with reference to FIG. 1 (RELATED ART) in order to assist understanding of the present invention.

First, when hydrogen is supplied to an anode of the fuel cell stack, unreacted hydrogen which does not react is discharged to an outlet terminal of the anode, and in this case, water contained in the unreacted hydrogen drops by gravity to be collected in the water trap and hydrogen from which droplets are removed is recirculated to an inlet terminal of the anode.

In this case, a water level of the water collected in a water trap 10 is detected by a water level sensor 12 mounted on the water trap 10 in real time, and the water level sensor 12 is constituted by a water level detecting electrode 12-1 and a circuit board (PCB) 12-2 transmitting a water level detection signal to a control unit.

Therefore, when the control unit determines that the water level in the water trap 10 is a predetermined level or more based on the water level detection signal transmitted from the water level sensor 12, the water in the water trap is discharged to the outside by opening control of a drain valve 14 positioned at the bottom of the water trap.

The water level sensor 12 mounted on the water trap 10 as a capacitive analog water level sensor shows a water level output within a normal range under a room temperature condition, but shows an output different from an actual water level when the temperature of the water and a surrounding environmental temperature are changed.

For example, the water level sensor 12 has a tendency to output a water level which is higher than the actual water level as the temperature of the water increases.

In order to solve the problem, the present invention places emphasis on detecting a change in a surrounding temperature of a water level sensor by mounting a separate temperature sensor in the water level sensor and accurately outputting the water level in the water trap regardless of the change of the surrounding temperature through a temperature correction algorithm based on a detected temperature.

The water level sensor for the water trap and an operating flow thereof according to the present invention will be described below.

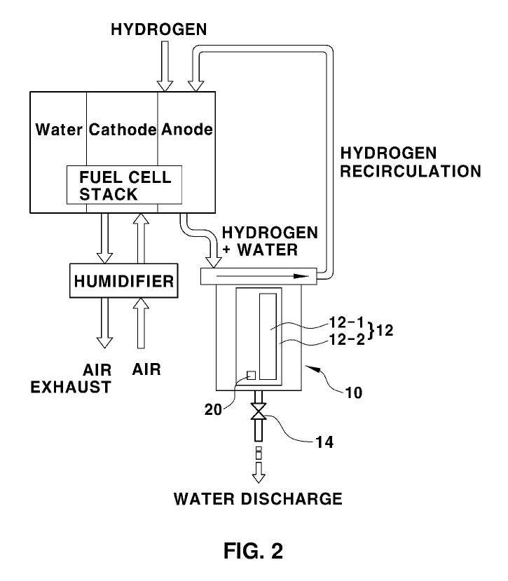

Referring to FIG. 2, a separate temperature sensor 20 is mounted in the water level sensor 12 mounted in the water trap 10.

The water level sensor 12 is adopted as the capacitive analog water level sensor constituted by the water level detecting electrode 12-1 and the circuit board (PCB) 12-2 transmitting the water level detection signal to the control unit and the temperature sensor 20 is mounted on an adjacent portion of the electrode 12-1 of the water level sensor 12.

The reason for mounting the temperature sensor 20 on the adjacent portion of the electrode 12-1 of the water level sensor 12 is that an output value of the water level sensor 12 is influenced by a temperature of the electrode 12-1.

Therefore, the output value of the water level sensor 12 influenced by the temperature is corrected by using a detection value of the temperature sensor 20, and as a result, the output value of the water level sensor 12 may be output to a level to accurately indicate the water level in the water trap regardless of a change of a surrounding temperature. A procedure of correcting the output value of the water level sensor in accordance with the surrounding temperature according to the present invention will be described below.

First, output data of the water level sensor for a condition in which the water level in the water trap is a low water level (empty) and a full water level (full) at a reference temperature Ta is acquired.

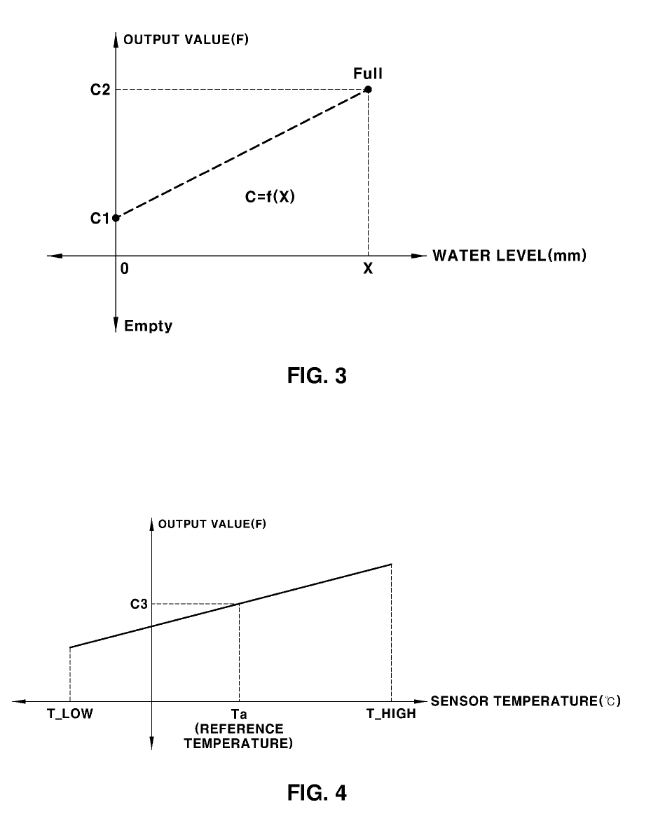

Output values C1 and C2 of the water level sensor for the condition in which the water level in the water trap is the low water level (empty) and the full water level (full) at the reference temperature Ta and an output value (C=f(x)) of the water level sensor in a section between the low water level (empty) and the full water level (full) are output substantially linearly as illustrated in FIG. 3.

Therefore, the output values C1 and C2 of the water level sensor for the condition in which the water level in the water trap is the low water level (empty) and the full water level (full) at the reference temperature Ta and the output value (C=f(x)) of the water level sensor in the section between the low water level (empty) and the full water level (full) are stored in a memory of the control unit.

Next, output value data of the water level sensor for each surrounding temperature under the condition in which the water level in the water trap is the low water level is acquired.

In this case, the reason for acquiring the output value of the water level sensor for each surrounding temperature only under the condition of the low water level is that the output values of the water level sensor for each surrounding temperature under the condition in which the water level in the water trap is the low water level, the condition between the low water level and the full water level, and the condition of the full water level are similarly changed.

Referring to FIG. 4, in the case of the change of the output value of the water level sensor for each surrounding temperature under the low water level (empty) condition, the output value at a temperature T_LOW lower than the reference temperature Ta is output to be lower than an output value C3 at the reference temperature Ta and the output value at a temperature T_HIGH higher than the reference temperature Ta is output to be higher than the output value C3. Therefore, this shows that the output value of the water level sensor is changed according to the surrounding temperature.

Subsequently, a correction value K for the output value of the water level sensor for each surrounding temperature (for example, for each surrounding temperature of the electrode) is calculated based on the output value of the water level sensor at the reference temperature Ta.

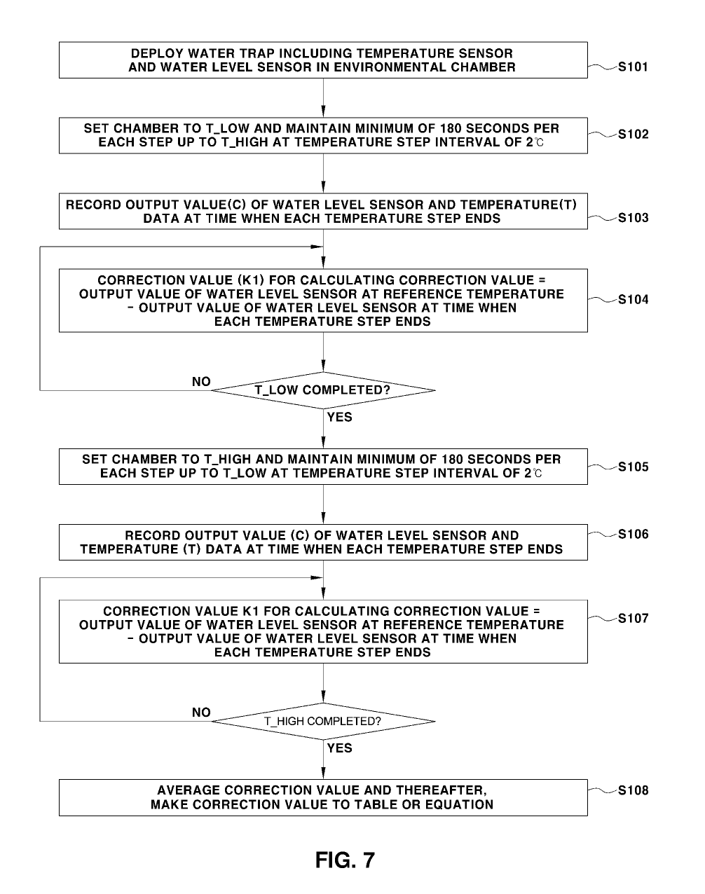

An example of a method for calculating the correction value K will be described below with reference to a flowchart of FIG. 7.

The water trap on which the water level sensor including the temperature sensor is mounted is deployed in an environmental chamber (S101).

Next, a temperature in the chamber is set to the temperature T_LOW lower than the reference temperature Ta and thereafter, increased to a predetermined temperature T_HIGH higher than the reference temperature Ta at a temperature step interval of 2° C. and a minimum of 180 seconds are maintained per each temperature step (S102).

In this case, the output value of the water level sensor and current temperature data are recorded at the time when each temperature step ends (S103).

Subsequently, the output value of the water level sensor at the time when each temperature step ends is subtracted from the output value of the water level sensor at the reference temperature to calculate the correction value K for correcting the output value of the water level sensor (S104).

Meanwhile, the temperature in the chamber is set to the temperature T_HIGH higher than the reference temperature Ta, and thereafter, the correction value is calculated once again, in order to increase the accuracy of the calculation of the correction value K.

To this end, the temperature in the chamber is set to the temperature T_HIGH higher than the reference temperature Ta and thereafter, decreased to a predetermined temperature T_LOW lower than the reference temperature Ta at the temperature step interval of 2° C. and a minimum of 180 seconds are maintained per each temperature step (S105).

Even in this case, the output value of the water level sensor and current temperature data are recorded at the time when each temperature step ends (S106).

Similarly, the output value of the water level sensor at the time when each temperature step ends is subtracted from the output value of the water level sensor at the reference temperature to calculate the correction value K for correcting the output value of the water level sensor (S107).

As described above, the step of calculating the correction value is repeated twice, and resulting values repeated twice are averaged to calculate a final correction value K (S108).

The finally calculated correction value K is made to a table or an equation to be stored in the memory of the control unit.

Accordingly, the output value of the water level sensor may be corrected for each surrounding temperature based on the calculated correction value.

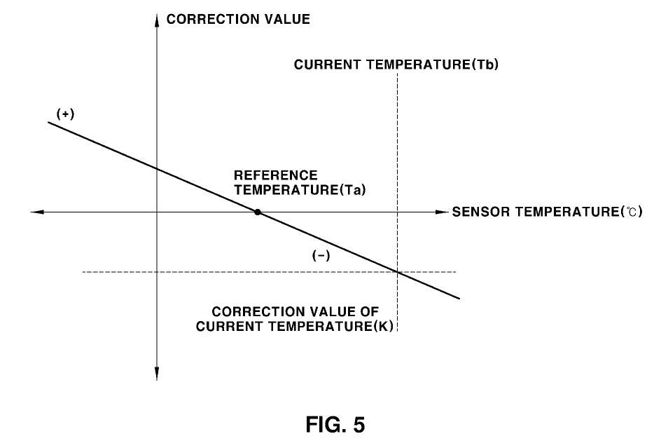

In particular, when a current temperature Tb detected by the temperature sensor is different from the reference temperature Ta as illustrated in FIG. 5, the correction value K corresponding to the current temperature Tb is found in the memory of the control unit, and an output value of the water level sensor on which the found correction value K is reflected is output.

For example, assuming that the reference temperature Ta is 10° C. and the output value of the water level sensor at the reference temperature Ta of 10° C. is 100, and assuming that the current temperature Tb detected by the temperature sensor is −10° C. and that the output value of the water level sensor at the current temperature Tb of −10° C. is 50, the correction value becomes 50, and consequently, the output value of the water level sensor, on which the correction value of 50 is reflected becomes 100.

As described above, the separate temperature sensor is mounted in the water level sensor to detect the change of the current surrounding temperature of the water level sensor and correct and output the output value of the water level sensor for each current detected temperature according to the output value of the water level sensor at the reference temperature, and as a result, the water level sensor can continuously output the water level in the water trap with accuracy regardless of the change of the surrounding temperature.

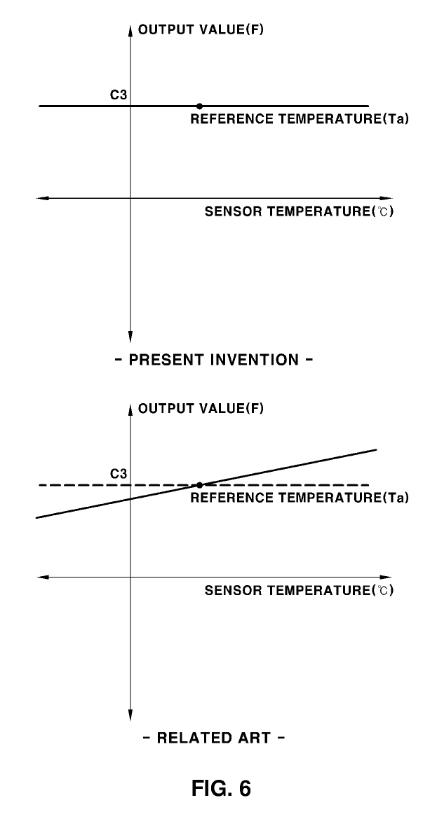

In other words, the output value of the water level sensor for each surrounding temperature for a specific water level varies as compared with the output value at the reference temperature Ta as illustrated in FIG. 6 in the related art, but according to the present invention, a constant output value of the water level sensor at the specific water level may be output as compared with the output value at the reference temperature Ta regardless of the surrounding temperature, and consequently, the accuracy of the output value indicating the water level of the capacitive analog water level sensor may be improved.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for detecting a water level of a water trap, the device comprising:
a water level sensor mounted on the water trap;
a temperature sensor mounted on the water level sensor; and
a control unit correcting an output value of the water level sensor depending on a current detection temperature of the temperature sensor to an output value of the water level sensor depending on a reference temperature.

2. The device of claim 1, wherein the temperature sensor is mounted on a periphery of an electrode of the water level sensor.

3. The device of claim 1, wherein the control unit stores a correction value for correcting an output value of the water level sensor for each current temperature detected by the temperature sensor to the output value of the water level sensor depending on the reference temperature.

4. A method for detecting a water level of a water trap, the method comprising the steps of:
i) acquiring, by a control unit, output data of a water level sensor at a reference temperature;
ii) acquiring, by a control unit, output value data of the water level sensor for each surrounding temperature;
iii) calculating, by a control unit, a correction value for the output value of the water level sensor for each surrounding temperature based on an output value of the water level sensor at the reference temperature; and
iv) correcting, by a control unit, the output value of the water level sensor for each surrounding temperature based on the calculated correction value.

5. The method of claim 4, wherein in step i), as the output data of the water level sensor, an output value of the water level sensor for a condition in which a water level in the water trap is a low water level or a full water level at the reference temperature and an output value of the water level sensor in a section between the low water level and the full water level are acquired.

6. The method of claim 4, wherein in step ii), the output value data of the water level sensor for each surrounding temperature is acquired under the condition in which the water level in the water trap is the low water level.

7. The method of claim 4, wherein step iii) includes:
iii-1) a process of setting a temperature in a chamber to a temperature lower than the reference temperature Ta and thereafter, increasing the temperature in the chamber to a predetermined temperature higher than the reference temperature at a predetermined temperature step interval, in a state in which the water trap on which the water level sensor including a temperature sensor is mounted is deployed in an environmental chamber, the temperature in the chamber being increased while maintaining each temperature step for a predetermined time;
iii-2) a process of recording the output value of the water level sensor and current temperature data at the time when each temperature step ends; and
iii-3) a process of subtracting the output value of the water level sensor at the time when each temperature step ends from the output value of the water level sensor at the reference temperature to calculate the correction value for correcting the output value of the water level sensor.

8. The method of claim 7, further comprising:
after step iii-3),
iii-4) a process of setting the temperature in the chamber to the temperature higher than the reference temperature and thereafter, decreasing the temperature in the chamber to the predetermined temperature lower than the reference temperature at the predetermined temperature step interval, the temperature in the chamber being decreased while maintaining each temperature step for a predetermined time;
iii-5) a process of recording the output value of the water level sensor and the current temperature data at the time when each temperature step ends;
iii-6) a process of subtracting the output value of the water level sensor at the time when each temperature step ends from the output value of the water level sensor at the reference temperature to calculate the correction value for correcting the output value of the water level sensor; and
iii-7) calculating a final correction value by averaging the correction value calculated in step iii-3) and the correction value calculated in step iii-6).

9. The method of claim 4, wherein step iv) is achieved by finding, when a current temperature detected by a temperature sensor is different from the reference temperature, the correction value corresponding to the current temperature in a memory of a control unit and outputting an output value of the water level sensor, on which the found correction value is reflected.

10. A non-transitory computer readable medium containing program instructions executed by a processor, the computer readable medium comprising:
program instructions that acquire output data of a water level sensor at a reference temperature;
program instructions that acquire output value data of the water level sensor for each surrounding temperature;
program instructions that calculate a correction value for the output value of the water level sensor for each surrounding temperature based on an output value of the water level sensor at the reference temperature; and
program instructions that correct the output value of the water level sensor for each surrounding temperature based on the calculated correction value.
